(19) United States
(12) Patent Application Publication
(10) Pub. No.: US 2011/0151255 A1
(43) Pub. Date: Jun. 23, 2011

(54) NANOFIBER AND PREPARATION METHOD THEREOF

(75) Inventors: Il Doo Kim, Seoul (KR); Soo Hyun Kim, Andong-si (KR)

(73) Assignee: KOREA INSTITUTE OF SCIENCE AND TECHNOLOGY, Seoul (KR)

(21) Appl. No.: 12/754,412

(22) Filed: Apr. 5, 2010

(30) Foreign Application Priority Data
Dec. 23, 2009 (KR) 10-2009-0129884

(51) Int. Cl. D02G 3/22; D02G 3/02; B29C 47/88; B29C 71/02

(52) U.S. Cl. 428/372; 428/401; 264/211.12; 264/465

(57) ABSTRACT

A nanofiber, which is prepared by using a fabrication method comprising the steps of spinning a spinning solution prepared by dissolving at least one precursor for metal, metal oxide, or metal complex oxide with a polymer mixture comprising at least two polymers having different molecular weights and glass transition temperatures in a solvent and thermally treating the spun fiber, comprises close-packed nanoparticles of a metal, a metal oxide, a metal complex oxide or a mixture thereof and has excellent structural, thermal, and mechanical stability as well as a uniform fiber-shape.

### FIELD OF THE INVENTION

The present invention relates to a uniform nanofiber having excellent structural, thermal, and mechanical stability, and a preparation method thereof.

### BACKGROUND OF THE INVENTION

There has been a growing interest in environmentally friendly and high-efficiency energy storage and electricity generating devices such as secondary battery, solar cell, and fuel cell. To improve the efficiencies of such devices, extensive studies on nanostructural materials have been conducted, because a nanostructure has a large specific surface area as compared to the bulk to provide a high reaction efficiency at the surface, which makes it possible to fabricate highly efficient, miniaturized devices. Nanostructural materials can be produced by using such methods as hydrothermal, sol-gel, emulsion polymerization, templating, suspension polymerization, dispersion polymerization, sputtering, chemical vapor deposition, self-assembled monolayer, plating/electroless plating, electrospinning, and other methods, but it has been difficult to produce metal, metal oxide or metal complex oxide nanostructures having good structural stability due to many difficult problems, e.g., high process cost, complicated manufacturing steps, low yield, and instability of the nanostructured product.

The electrospinning method has been usually used to fabricate one-dimensional nanofiber. A nanofiber composed of a metal or a metal oxide as well as a polymer can be fabricated by electrospinning. A nanofiber fabricated by electrospinning generally has a large specific surface area and high porosity. As a result, such a nanofiber has its own special properties which are distinctly different from those of conventional two-dimensional thin films, three-dimensional thick films, or bulk materials, and it is suitable for application in the fields of tissue engineering, drug delivery, membrane, filter, solar cells, chemical and bio sensors, and others.

Generally, an electrospinning apparatus comprises a syringe pump to extrude a precursor liquid having a sufficiently high molecular cohesion so that the extruded liquid stream does not breakup to form droplets, a DC power supply, a needle tip provided at the syringe pump's outlet, and a grounded substrate. A polymer liquid (polymer, organic/inorganic hybrid precursor etc.) discharged from the syringe pump forms a hemispherical droplet at the tip of the needle because of the balance between gravity and the liquid's surface tension. When a sufficiently high electric voltage is applied to the droplet, the hemispherical droplet becomes charged, and the resulting electrostatic repulsion counters the surface tension, converting the hemispherical droplet into the shape of a cone, which is called the Taylor cone. When a critical voltage is applied, the repulsive electrostatic force becomes larger than the surface tension, and a jet of the charged polymer liquid is discharged from the end of the Taylor cone. When polymer liquid having a low viscosity, the jet breaks into microdroplets, but a polymer liquid having a sufficiently high viscosity, the jet becomes a continuous fiber of the charged polymer liquid, the solvent of the polymer liquid fiber is evaporated, and a continuous fiber accumulates on the grounded substrate, often in the form of a web. A metal precursor/polymer complex fiber or a metal oxide precursor/polymer complex fiber converts to a metal or metal oxide nanofiber by thermal treating under an oxidation or reduction atmosphere. But, it is difficult to form a nanofiber having a stable structural property because the thermal treating is generally carried out at a high temperature of 500° C. to remove the polymer. Specially, it is more difficult to prepare a multi-component nanofiber having a complex composition. Further, when a web of nanofibers is obtained, the shape of the nanofiber may collapse due to melting of the polymer component of the nanofiber, leading to a structure of a thin layer of discontinuous fibers.

Accordingly, in order to fabricate a nanofiber having a uniform fiber shape, it is important to use a specific polymer which is capable of maintaining the nanofiber shape after subsequent thermal treatment at an elevated temperature.

### SUMMARY OF THE INVENTION

Accordingly, it is an object of the present invention to provide a uniform nanofiber having excellent structural, thermal, and mechanical stability.

It is another object of the present invention to provide a preparation method of the nanofiber.

In accordance with one aspect of the present invention, there is provided a nanofiber comprising close-packed nanoparticles, wherein the nanoparticles are selected from the group consisting of a metal, a metal oxide, a metal complex oxide, and a mixture thereof, the nanofiber comprises micropores having an average pore diameter of 0.1 nm to 20 nm formed between nanoparticles and a porosity per unit volume in the range of 0.01% to 10%.

In accordance with another aspect of the present invention, there is provided a method for preparing the nanofiber, comprising:

preparing a spinning solution by mixing at least one precursor for metal, metal oxide, and metal complex oxide with a polymer mixture comprising at least two polymers having different molecular weights and glass transition temperatures in a solvent;

spinning the spinning solution to obtain a precursor/polymer complex fiber; and

thermally treating the precursor/polymer complex fiber.

### BRIEF DESCRIPTION OF DRAWINGS

The above and other objects and features of the present invention will become apparent from the following description of the invention taken in conjunction with the following accompanying drawings, which respectively show:

FIG. 1: a scanning electron microscopy (SEM) image of the tin oxide nanofiber fabricated in Example 1;

FIG. 2: a high magnification SEM image of FIG. 1;

FIG. 3: a transmission electron microscopy (TEM) image of the tin oxide nanofiber fabricated in Example 1;

FIG. 4: an SEM image of the zinc oxide nanofiber fabricated in Example 2;

FIG. 5: a high magnification SEM image of FIG. 4;

FIG. 6a: a TEM image of the tin oxide nanofiber fabricated in Example 2;

FIG. 6b: a high magnification TEM image of FIG. 6a;

FIG. 7: an SEM image of the tin precursor/PVP-PMMA complex nanofiber electrospun on the collector in Example 3;

FIG. 8: an SEM image of the tin-carbon nanofiber fabricated in Example 3;

FIG. 9: a TEM image of the tin-carbon nanofiber fabricated in Example 3; and

FIG. 10: an SEM image of the nanofiber fabricated in Comparative Example 1.

### DETAILED DESCRIPTION OF THE INVENTION

The present invention is characterized in that a nanofiber is fabricated by using at least two polymers having different molecular weights and glass transition temperatures and subjecting the nanofiber to three consecutive thermal treatment steps to obtain a uniform-shaped nanofiber having improved structural, thermal, and mechanical stability, which does not collapse to form a stable structure even after further thermal treatments.

Specifically, the method of the present invention comprises the following steps of: (1) preparing a spinning solution; (2) forming a precursor/polymer composite fiber by spinning; and (3) thermally treating the composite fiber.

Hereinafter, the individual steps of the method will be explained in detail.

### Step (1): Preparing a Spinning Solution

In this step, at least one precursor for metal, metal oxide, or metal complex oxide, and a mixture of at least two polymers having different molecular weights and glass transition temperatures are dissolved in a solvent to prepare a spinning solution.

The polymer raises the viscosity of the spinning solution for forming a fiber upon spinning and to control the structure of the spun fiber due to its compatibility with the precursor for metal, metal oxide, or metal complex oxide.

It is preferred that a mixture of at least two polymers having different molecular weights and glass transition temperatures, is used as the polymer.

Preferably, the polymer mixture comprises a 1st polymer having an average weight molecular of 1,000,000 or more, and a 2nd polymer having an average weight molecular of 500,000 or less. More preferably, the polymer mixture comprises the 1st polymer and 2nd polymer in a weight ratio of x:1-x (wherein, x is 0.2 to 0.8, preferably 0.3 to 0.7).

To use the polymer mixture comprising the high-molecular weight polymer and low-molecular weight polymer makes Tg (glass transition temperature) wider, that slows down the decomposition rate of the polymer. The 2nd polymer having the low-molecular weight is intimately and uniformly packed in the 1st polymers having the high-molecular weight to form a precursor/polymer complex fiber having a high packing density.

The Tg of polymer depends on the molecular weight of polymer. Generally, the higher the molecular weight of a polymer, the higher Tg becomes. The 1st polymer and 2nd polymer have different glass transition temperatures in the range of 25° C. to 400° C., and preferably the difference of the glass transition temperatures of the 1st polymer and 2nd polymer is 30° C. or more.

As the 1st polymer and 2nd polymer, a thermosetting resin or thermoplastic resin may be used. Examples for the 1st and 2nd polymer includes, but are not limited to, polyvinyl acetate and a copolymer thereof; polyurethane and a copolymer thereof; a cellulose derivative, such as cellulose acetate, cellulose acetate butyrate, and cellulose acetate propionate; a vinyl-based resin, such as polyvinyl alcohol (PVA), polyvinyl pyrrolidone (PVP), polyvinyl fluoride, and polyvinyl chloride (PVC); a (meth)acylate-based resin, such as polyfurfuryl alcohol (PPFA); polymethylmethacrylate (PMMA), and polymethylacrylate (PMA); polystyrene (PS) and a copolymer thereof; a polyalkylene oxide and a copolymer thereof, such as polyethylene oxide (PEO), polypropylene oxide (PPO), a polyethylene oxide copolymer, and a polypropylene oxide copolymer; a polycarbonate (PC); polycaprolactone; a polyacryl copolymer; a polyvinylidene fluoride (PVDF) copolymer; and polyamide. The 1st polymer and 2nd polymer include one or more polymers selected from these polymers respectively.

More preferable examples of the 1st polymer and 2nd polymer include (PVP)x(PMMA)1-x, (PVP)x(PVDF)1-x, (PVP)x(PAN)1-x, (PVP)x(PANI)1-x, (PVP)x(PDMS)1-x, (PVP)x(P3HT)1-x, (PVP)x(P3DDT)1-x, (PVP)x(PEA)1-x, (PVP)x(LDPE)1-x, (PVP)x(PEG)1-x, (PVP)x(PEMA)1-x, (PVP)x(MEH-PPV)1-x, (PVP)x(PP)1-x, (PVP)x(PS)1-x (PVP)x(PVA)1-x, (PVP)x(PVC)1-x, (PVP)x(PEO)1-x, (PVP)x(PMA)1-x, (PVP)x(PPO)1-x, (PVP)x(PC)1-x, (PVP)x(PVF)1-x, (PVP)x(PVAc)1-x, (PS)x(PMMA)1-x, (PS)x(PVDF)1-x, (PS)x(PAN)1-x, (PS)x(PANI)1-x, (PS)x(PDMS)1-x, (PS)x(P3HT)1-x, (PS)x(P3DDT)1-x, (PS)x(PEA)1-x, (PS)x(LDPE)1-x, (PS)x(PEG)1-x, (PS)x(PEO)1-x, (PS)x(PEMA)1-x, (PS)x(MEH-PPV)1-x, (PS)x(PP)1-x, (PS)x(PVA)1-x, (PS)x(PVC)1-x, (PS)x(PEO)1-x, (PS)x(PMA)1-x, (PS)x(PC)1-x, (PS)x(PVF)1 -x, (PS)x(PVAc)1-x, (HDPE)x(PMMA)1-x, (HDPE)x(PVDF)1-x, (HDPE)x(PAN)1-x, (HDPE)x(PANI)1-x, (HDPE)x(PDMS)1-x, (HDPE)x(P3HT)1-x, (HDPE)x(P3DDT)1-x, (HDPE)x(PEA)1-x, (HDPE)x(PEG)1-x, (HDPE)x(PEO)1-x, (HDPE)x(PEMA)1-x, (HDPE)x(MEH-PPV)1-x, (HDPE)x(PP)1-x, (HDPE)x(PVA)1-x, (HDPE)x(PVC)1-x, (HDPE)x(PEO)1-x, (HDPE)x(PMA)1-x, (HDPE)x(PPO)1-x, (HDPE)x(PC)1-x, (HDPE)x(PVF)1-x, (HDPE)x(PVAc) 1 -x, (PEO)x(PMMA)1-x, (PEO)x(PVDF)1-x, (PEO)x(PAN)1-x, (PEO)x(PANI)1 -x, (PEO)x(PDMS)1-x, (PEO)x(P3HT)1-x, (PEO)x(P3DDT) 1 -x, (PEO)x(PEA)1-x, (PEO)x(LDPE)1-x, (PEO)x(PEG)1-x, (PEO)x(PEMA)1-x, (PEO)x(MEH-PPV) 1-x, (PEO)x(PP)1-x, (PEO)x(PVA)1-x, (PEO)x(PVC)1-x, (PEO)x(PEO)1-x, (PEO)x(PMA)1-x, (PEO)x(PPO)1-x, (PEO)x(PC)1-x, (PEO)x(PVF)1-x, (PEO)x(PVAc)1-x, (PVAc)x(PMMA)1-x, (PVAc)x(PVDF)1-x, (PVAc)x(PAN)1-x, (PVAc)x(PANI)1-x, (PVAc)x(PDMS)1-x, (PVAc)x(P3HT)1-x, (PVAc)x(P3DDT)1-x, (PVAc)x(PEA)1-x, (PVAc)x(LDPE)1-x, (PVAc)x(PEG)1-x, (PVAc)x(PEO)1-x, (PVAc)x(PEMA)1-x, (PVAc)x(MEH-PPV)1-x, (PVAc)x(PP)1-x, (PVAc)x(PS)1-x (PVAc)x(PVA)1-x, (PVAc)x(PVC)1-x, (PVAc)x(PEO)1-x, (PVAc)x(PMA)1-x, (PVAc)x(PPO)1-x, (PVAc)x(PC)1-x, (PVAc)x(PVF)1-x, (PVK)x(PMMA)1-x, (PVK)x(PVDF)1-x, (PVK)x(PAN)1-x, (PVK)x(PANI)1-x, (PVK)x(PDMS)1-x, (PVK)x(P3HT)1-x, (PVK)x(P3DDT)1-x, (PVK)x(PEA)1-x, (PVK)x(LDPE)1-x, (PVK)x(PEG)1-x, (PVK)x(PEO)1-x, (PVK)x(PEMA)1-x, (PVAc)x(MEH-PPV)1-x, (PVK)x(PP)1-x, (PVK)x(PS)1-x (PVK)x(PVA)1-x, (PVK)x(PVC)1-x, (PVK)x(PEO)1-x, (PVK)x(PMA)1-x, (PVK)x(PPO)1-x, (PVK)x(PC)1-x, (PVK)x(PVF)1-x, (PAA)x(PMMA)1-x, (PAA)x(PVDF)1-x, (PAA)x(PAN)1-x, (PAA)x(PANI)1-x, (PAA)x(PDMS)1-x, (PAA)x(P3HT)1-x, (PAA)x(P3DDT)1-x, (PAA)x(PEA)1-x, (PAA)x(LDPE)1-x, (PAA)x(PEG)1-x, (PAA)x(PEO)1-x, (PAA)x(PEMA)1-x, (PAA)x(MEH-PPV)1-x, (PAA)x(PP)1-x, (PAA)x(PS)1-x (PAA)x(PVA)1-x, (PAA)x(PVC)1-x, (PAA)x(PEO)1-x, (PAA)x(PMA)1-x, (PAA)x(PPO)1-x, (PAA)x(PC)1-x, (PAA)x(PVF)1-x, and a mixture thereof, wherein x is 0.2 to 0.8, preferably 0.3 to 0.7, PVP refers to polyvinylpyrrolidone, PMMA refers to polymethylmethacrylate, PVDF refers to polyvinylidene fluoride, PAN refers to polyacrylonitrile, PANI refers to polyaniline, PDMS refers to poly(dimethylsiloxane), P3HT refers to poly(3-hexylthiophene, P3DDT refers to poly(3-dodecylthiophene), PEA refers to poly(ethyl acrylate), LDPE refers to low density polyethylene, PEG refers to poly(ethylene glycol), PEMA refers to poly(ethyl methacrylate), MEH-PPV refers to poly(2-methoxy-5-(2-ethylhexyloxy)-1,4-phenylenevinylene), PP refers to polypropylene, PVF refers to poly(vinyl fluoride), PVAc refers to polyvinylacetate, HDPE refers to High Density Polyethylene, PVK refers to poly(N-vinyl carbazole), and PAA refers to polyacrylamide.

There is no particular limitation on the combination of the polymers. In another embodiment of the present invention, the polymer mixture comprising 3 or more polymers may be used as a polymer.

There is no particular limitation on the kind of the precursor for metal, metal oxide, or metal complex oxide (hereinafter, refer to “precursor”) so long as the precursor is able to convert to a metal, a metal oxide, or a metal complex oxide by thermal treating under an oxidation or reduction atmosphere.

Examples for the precursor include, but not limited to, a metal salt, metal halide; metal alkoxide; metal cyanine; metal sulfide; metal amide; metal cyanide; metal hydride; metal peroxide; metal porphine; metal nitride; metal hydrate; metal hydroxide, and an ester comprising a metal which is selected from the group consisting of platinum (Pt), nickel (Ni), gold (Au), iron (Fe), cobalt (Co), molybdenum (Mo), indium (In), iridium (Ir), silicon (Si), silver (Ag), tin (Sn), titanium (Ti), cupper (Cu), palladium (Pd), ruthenium (Ru), zinc (Zn), strontium (Sr), lithium (Li), manganese (Mn), lanthanum (La), aluminium (Al), vanadium (V), barium (Ba), and magnesium (Mg).

In order to fabricate a tin nanofiber, tin acetate, tin bromide, tin chloride, tin butoxide, tin fluoride, tin iodide, tin oxalate, tin oxide, tin cyanine, tin phosphate, tin sulfate, tin sulfide, or tin sulfonate may be used as a precursor.

In order to fabricate a ZnO nanofiber as a metal oxide nanofiber, zinc acetate, zinc citrate, zinc acetylacetonate, zinc acrylate, zinc amide, zinc borohydride, zinc bromide, zinc chloride, zinc cholorothiophenolate, zinc cyanide, zinc cyclohexanebutylrate, zinc butylsalicylate, zinc carbamate, zinc fluoride, zinc silicate, zinc iodide, zinc methacrylate, zinc napthenate, zinc nitrate, zinc cyanine, zinc oxalate, zinc oxide, zinc perchlorate, zinc peroxide, zinc phosphate, zinc phthalocyanine, zinc stearate, zinc sulfate, zinc sulfide, or zinc porphine may be used as a precursor.

Examples for the other precursor include, but not limited to, titanium butoxide, titanium chloride, titanium ethoxide, titanium nitride, titanium isopropoxide, titanium oxysulfate, titanium oxide-acetylacetonate, titanium sulfate, titanium sulfide, titanium propoxide, strontium acetate, strontium chloride 4-hydrate, strontium isopropoxide, strontium oxalate, strontium peroxide, lithium acetate, lithium chloride, lithium isopropoxide, lithium sulfate, lithium nitrate, lithium acetylacetonate, manganese acetylacetonate, manganese chloride, manganese hydride, manganese hydroxide, manganese methoxide, manganese nitrate, manganese perchloride, manganese phosphate, manganese sulfate, manganese acetate4-hydrate, silicon nitride, silicon tetraacetate, ruthenium chloride, ruthenium acetylacetonate, tin chloride, tin acetate, tin acetylacetonate, tin chloride, tin oxalate, tin sulfate, nickel acetate, nickel acetylacetonate, nickel nitrate, nickel chloride, nickel oxalate, nickel perchlorate, nickel peroxide, nickel phosphate, nickel sulfate, nickel sulfide, nickel nitrate, nickel triphenylphosphine, lanthanum chloride-7-hydrate, chloroplatinic acid hexahydrate (H₂PtCl₆H₂O), iron acetate, iron acetylacetonate, iron chloride, iron ethoxide, iron nitrate, iron oxalate, iron phosphate, iron sulfate, iron sulfide, iron isopropoxide, aluminium acetate, aluminium butoxide, aluminium chloride, aluminium ethoxide, aluminium hydroxide, aluminium isopropoxide, aluminium nitride, aluminium phosphate, aluminium perchlorate, aluminium sulfate, aluminium sulfide, cobalt acetate, cobalt acetylacetonate, cobalt chloride, cobalt hydroxide, cobalt nitrate, cobalt sulfate, zinc acetate, zinc acetylacetonate, zinc bromide, zinc chloride, zinc fluoride, zinc nitrate, zinc peroxide, zinc sulfate, zinc sulfide, vanadium acetylacetonate, vanadium acetylacetonate, vanadium chloride, barium acetate, barium isopropoxide, barium nitrate, barium perchlorate, barium sulfate, barium chloride, magnesium acetate, magnesium acetylacetonate, magnesium bromide, magnesium chloride, magnesium nitrate, magnesium nitride, magnesium perchlorate, magnesium phosphate, magnesium sulfate copper acetate, copper acetylacetonate, copper chloride, copper iodide, copper perchlorate, copper sulfate, copper sulfide, and copper tetrahydrate.

It is preferred that the precursor is used in an amount of 50% to 300% by weight based on the total weight of the polymer mixture. When the amount of the used precursor is too small, a nanofiber forming property deteriorates after a thermal treatment. And, it is difficult to use the precursor in an amount of 300% by weight or more due to its solubility limit.

There is no particular limitation on the kind of the solvent so long as the solvent is able to dissolve a polymer and precursor. Accordingly, as a solvent, preferred is a polar or non-polar solvent. Examples for the solvent include, but not limited to, dimethylformamide (DMF), acetone, tetrahydrofuran, toluene, water, ethanol, and a mixture thereof.

At least one additive can be added to the spinning solution to facilitate the spinning. Examples for the additive include, but not limited to, acetic acid, stearic acid, adipic acid, ethoxy acetic acid, benzoic acid, nitric acid, cetyltrimethyl ammonium bromide (CTAB), and a mixture thereof.

### Step (2): Forming a Precursor/Polymer Composite Fiber by Spinning

In this step, the spinning solution prepared in Step (1) is spun on a surface of a current collector to form a precursor/polymer composite fiber.

The precursors and the polymer undergo phase separation or intermixing upon spinning to form an ultrafine fiber of the precursors/polymer composite. The ultrafine fiber accumulates randomly on the current collector to form a web of entangled ultrafine fibers.

Examples for the spinning process include, but not limited to, electrospinning, melt-blowing, flash spinning, and electrostatic melt-blowing. Electrospinning was employed in Examples of the present invention.

A device suitable for the electrospinning comprises a spinning nozzle connected to a pump to quantitatively feed the spinning solution, a high voltage generator, and an electrode (i.e. a current collector) on which a layer composed of spun fibers is formed, etc. The current collector is used as an anode and the spinning nozzle is used as a cathode. The pump controls the amount of the spinning solution discharged per hour. For example, the precursor/polymer complex fibers having an average diameter of 50 nm to 3,000 nm may be produced by discharging the spinning solution at a rate of 10 μl/min to 50 μl/min while a voltage of 7 kV to 30 kV is applied. The conditions for the electrospinning (i.e. a distance between a tip and each electrode) may be controlled within a common range. The thickness of the layer comprising the precursor/polymer composite fiber can be controlled depending on the discharging amount or electric field strength. It is preferred to perform the electrospinning until the layer of the precursor/polymer composite fiber web having a thickness of 0.5 μm to 100 μm is formed on the current collector. The temperature and humidity conditions for the electrospinning are suitably selected taking into consideration a solvent-volatilization and a partial sol-gel reaction generated in the electrospinning process. Preferably, the electrospinning is performed at a temperature of 10° C. to 35° C. and at a humidity of 15% to 45%.

Step (3): Thermally Treating the Composite Fiber

In this step, the three consecutive thermal treatment steps are conducted to the composite fiber formed in step (2) to oxidize or reduce the precursor component of the composite fiber, while the polymer is carbonized or removed. As a result, a nanofiber composed of a metal, a metal oxide, a metal complex oxide or a mixture thereof is fabricated.

The thermal treatment comprises a first thermal treatment to volatilize a solvent; a second thermal treatment to induce a sol-gel reaction and to raises structural stability of the composite fiber; and a third thermal treatment to induce an oxidation/reduction of the precursor and to remove or carbonize the polymer.

The first thermal treatment is performed by heating the composite fiber formed in step (2) at a rate of 1° C. to 2° C. per minute, followed by maintaining at the temperature of 50° C. to 200° C., preferably 100° C. to 150° C. for 1 hour.

The second thermal treatment is performed at a temperature below the glass transition temperature of the polymer to inhibit a sudden transformation of the polymer and to progress gradually a sol-gel reaction, preferably by heating the resulting composite fiber formed in the first thermal treatment at a rate of 1° C. to 2° C. per minute, followed by maintaining at the temperature of 250° C. to 350° C. for 1 hour.

The third thermal treatment is performed by heating the resulting composite fiber in the second thermal treatment at a rate of 1° C. to 5° C. per minute, preferably 1° C. to 2° C. per minute, followed by maintaining at the temperature of 300° C. to 900° C. for 1 hour to 10 hours.

The temperature condition for the third thermal treatment is suitably selected taking into consideration the kind of the used precursor. In order to fabricate a nanofiber composed of crystalline nanoparticles, it is preferred to conduct the third thermal treatment at a temperature of 400° C. to 900° C. And, in order to fabricate a nanofiber composed of amorphous nanoparticles, it is preferred to conduct the third thermal treatment at a temperature of 300° C. to 400° C.

Such thermal treatments are performed in the air, under an oxidation or reduction atmosphere (e.g., N₂/H₂ mixture gas, CO gas or NH₃ gas), or in a vacuum. For example, in order to form a nanofiber by using a metal precursor, it is preferred that the thermal treatments are performed under a reduction atmosphere or in a vacuum. In order to form a nanofiber by using a metal oxide precursor, it is preferred that the thermal treatments are performed in the air or under an oxidation atmosphere. More preferably, the first, second, and third thermal treatments are performed in a same condition, and the condition is suitably selected taking into consideration the desired nanofiber.

Due to the three consecutive thermal treatment steps, the polymer mixture is partially or completely removed and the precursor of the composite fiber is to be a crystallization or amorphization. As a result, a nanofiber composed of a metal, a metal oxide, a metal complex oxide or a mixture thereof is formed. But, when the third thermal treatment is performed at a low temperature, the polymer mixture may be partially remained in a form of the amorphous carbon in the nanofiber. Such amorphous carbon derived from the polymer mixture, raises the strength and thermal stability of the nanofiber.

The present invention provides a nanofiber which is prepared by using the above method and comprises close-packed nanoparticles, wherein the nanoparticles are selected from the group consisting of a metal, a metal oxide, a metal complex oxide, and a mixture thereof.

The metal comprises at least one metal selected from the group consisting of Pt, Ni, Au, Fe, Co, Mo, In, Ir, Si, Ag, Sn, Ti, Cu, Pd and Ru, or an alloy thereof. The metal oxide comprises a binary system-metal oxide such as SnO₂, Al₂O₃, TiO₂, Fe₂O₃, ZrO₂, V₂O₅, Fe₂O₃, CoO, Co₃O₄, CaO, MgO, CuO, ZnO, In₂O₃, NiO, MoO₃, and WO₃; a ternary system-metal oxide such as SnSiO₃, Zn₂SnO₄, CoSnO₃, Ca₂SnO₄, CaSnO₃, ZnCo₂O₄, Co₂SnO₄, Mg₂SnO₄, Mn₂SnO₄, CuV₂O₆, NaMnO₂, NaFeO₂, LiCoO₂, LiNiO₂, SrTiO₃, Li₄Ti₅O₁₂, BaTiO₃ and LiMn₂O₄; and a multi-component system-metal oxide such as LiFePO₄, Li[Ni_{1/3}Co_{1/3}Mn_{1/3}]O₂, Li[Ni_{1/2}Mn_{1/2}]O₂, LiNi₁₋ₓCoₓO₂ (0.1≦X≦0.9), LiAl_{0.05}Co_{0.85}Ni_{0.15}O₂, La₁₋ₓSrₓCoO₃ (0.1≦X≦0.9), La_{0.8}Sr_{0.2}Fe_{0.8}Co_{0.2}O₃, La₁₋ₓSrₓMnO₃ (0.1≦X≦0.9), and La₁₋ₓSrₓFeO₃ (0.1≦X≦0.9). The metal complex oxide comprises at least one selected from the group consisting of Pt—RuO₂, Au—RuO₂, Pt—IrO₂, Pt—TiO₂, Pd—SnO₂, Pd—TiO₂, Ni—Y_{0.08}Zr_{0.92}O₂, Ag—BaTiO₃, Pt—LaNiO₃, and Pt—Y_{0.08}Zr_{0.92}O₂.

Preferably the nanofiber of the present invention comprises close-packed nanoparticles having an average diameter of 5 nm to 200 nm. As a result, the nanofiber has a large specific surface area and a wide reaction region as well as a uniform fiber-shape.

The nanofiber of the present invention comprises micropores having an average pore diameter of 20 nm or less, preferably 0.1 nm to 10 nm formed between nanoparticles and a porosity per unit volume in the range of 0.01% to 10%. As a result, the nanofiber exhibits improved structural stability as well as excellent mechanical property.

Further, the nanofiber of the present invention which is prepared by using the polymer mixture of at least two polymers having different molecular weights and glass transition temperatures has a stable structure even after the thermal treatment of the precursor/polymer composite fiber accompanied by a sol-gel reaction. And, because the subsequent thermal treatment is conducted at the high temperature while maintaining the high packing density of the composite fiber, the fabricated nanofiber has improved thermal and mechanical stability. Further, because a solvent-volatilization, polymer stabilization and continuous sol-gel reaction progress continuously during the three consecutive thermal treatment steps, the formed nanofiber has an average fiber diameter of 50 nm to 3000 nm with a uniform fiber-shape. Particularly, the nanofiber has an aspect ratio (the ratio of the length of the nanofiber to its width) of 100 or more, preferably 100 to 1000.

The ultrafine fiber may be provided in a form of a nanoweb comprising a well connected network of nanofibers.

The nanofiber according to the present invention has excellent structural, thermal, and mechanical stability as well as a uniform fiber-shape, due to the close-packed nanoparticles of a metal, a metal oxide, a metal complex oxide or a mixture thereof.

The following Preparation Examples and Examples are intended to further illustrate the present invention without limiting its scope.

### EXAMPLE 1

### Fabrication of Tin Oxide Nanofiber

7.5 g of dimethyformamide (DMF, J. T. Baker) was placed in a 100 mL of bottle. 0.8 g of tin (IV) chloride (Mw 260.5) was added thereto and stirred until they were completely dissolved. To facilitate the spinning, 1 mL of acetic acid was added to the resulting solution and stirred for 1 min. A polymer mixture which is prepared by mixing 0.5 g of polyvinylpyrrolidone (PVP, Mw: 1,350,000, Tg: 180° C.) and 0.5 g of polymethylmetacrylate (PMMA, Mw: 350,000, Tg: 105° C.) in a weight ratio of 1:1 was added thereto and stirred until they were completely dissolved to prepare a tin oxide precursor/PVP-PMMA spinning solution. A small amount of cetyltrimethyl ammonium bromide (CTAB) was added to the spinning solution to facilitate the subsequent electrospinning. The spinning solution thus obtained was loaded in an amount of 10 mL into syringe and injected the surface of a current collector at a rate of 20 μl/min using a 30 G needle while maintaining a potential difference of about 13-15 kV, to form an ultrafine fiber web layer composed of the tin oxide precursor/PVP-PMMA composite fibers. A stainless steel (SUS) substrate was used as the current collector. The thickness of the ultrafine fiber web layer was controlled by varying the amount of the spinning solution discharged.

The tin oxide precursor/PVP-PMMA composite fibers deposited on SUS were heated at a rate of 1° C./min to 150° C., followed by maintaining for 1 hour in a tube furnace (the first thermal treatment). Then, the resulting complex fibers were heated at a rate of 1° C./min to 250° C., followed by maintaining for 1 hr (the second thermal treatment). And the resulting complex fiber was further heated at a rate of 1° C./min to 500° C., followed by maintaining for 1 hr (the third thermal treatment). After the thermal treatments, the resulting fiber was cooled to form a tin oxide nanofiber. Each of thermal treatments was performed in the air.

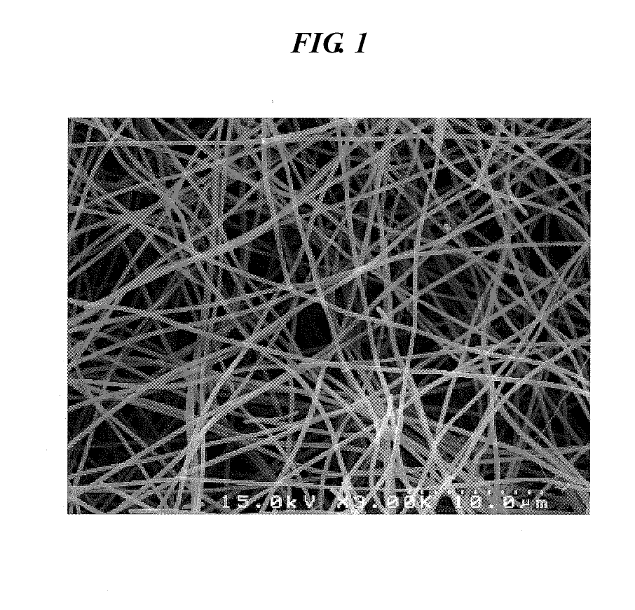

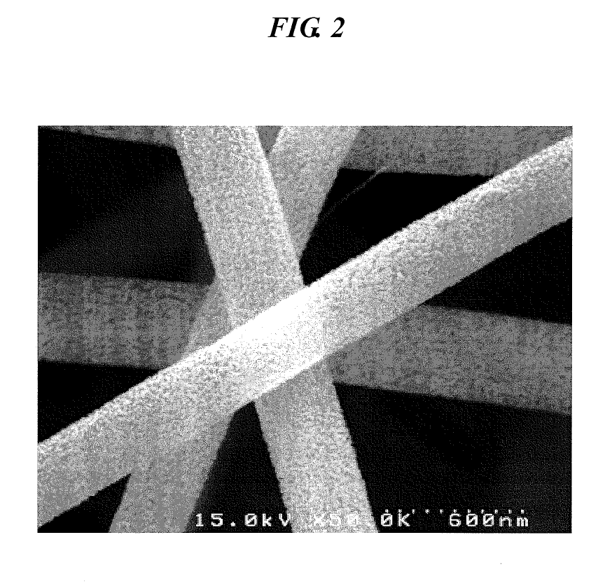

FIG. 1 is an SEM image(×3,000) of the tin oxide nanofiber fabricated in Example 1, and FIG. 2 is a high magnification SEM image of FIG. 1.

As shown in FIG. 1, the fabricated tin oxide nanofiber had a diameter of 200 nm to 400 nm. And as shown in FIG. 2, nanoparticles having a diameter of 10 nm to 15 nm were close-packed to form the nanofiber. Further, it can be seen that the straight nanofiber having an aspect ratio of 1000 or more was fabricated well from FIG. 1.

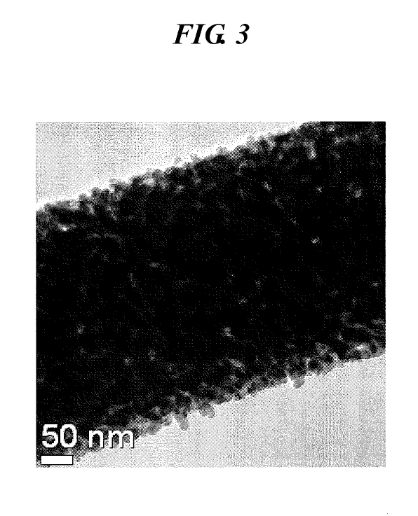

FIG. 3 is a TEM image of the tin oxide nanofiber.

As shown in FIG. 3, tin oxide nanoparticles having a diameter of 10 nm to 15 nm were close-packed to form a nanofiber. Specifically, the fabricated nanofiber comprised nano-sized pores having an average pore diameter of 3 nm or less, and a porosity per unit volume of about 5%. Such structural characteristic of the nanofiber as shown in FIG. 3, results from the sol-gel reaction accompanied by the thermal treatment which induces the generation and growth of the tin oxide nuclear to facilitate a uniform dispersion and growth of the tin oxide nuclear in the nanofiber. Especially, it can be seen that the fabricated nanofiber had a stable structure due to the polymer mixture of PVP and PMMA having different molecular weights and glass transition temperatures.

### EXAMPLE 2

### Fabrication of Zinc Oxide Nanofiber

7.5 g of dimethyformamide (DMF, J. T. Baker) was placed in a 100 mL of bottle. 0.8 g of zinc acetate (Mw 219.5) was added thereto and stirred until they were completely dissolved. To facilitate the spinning, 1 mL of acetic acid was added to the resulting solution and stirred for 1 min. A polymer mixture which is prepared by mixing 0.5 g of polyvinylpyrrolidone (PVP, Mw: 1,350,000, Tg: 180° C.) and 0.5 g of polymethylmetacrylate (PMMA, Mw: 350,000, Tg: 105° C.) in a weight ratio of 1:1, was added thereto and stirred until they were completely dissolved to prepared a zinc oxide precursor/PVP-PMMA spinning solution. A small amount of CTAB was added to the spinning solution to facilitate the subsequent electrospinning. The spinning solution thus obtained was loaded in an amount of 10 mL into syringe and injected the surface of a current collector at a rate of 15 μl/min using a 30 G needle while maintaining a potential difference of about 13-15 kV, to form an ultrafine fiber web layer. A stainless steel (SUS) substrate was used as the current collector. The thickness of the ultrafine fiber web layer was controlled to be 10 μm by varying the amount of the spinning solution discharged.

The zinc oxide precursor/PVP-PMMA complex fiber deposited on SUS was heated at a rate of 1° C./min to 150° C., followed by maintaining for 1 hour in a tube furnace (the first thermal treatment). Then, the resulting complex fiber was heated at a rate of 1° C./min to 250° C., followed by maintaining for 1 hr (the second thermal treatment). And the resulting complex fiber was further heated at a rate of 1° C./min to 500° C., followed by maintaining for 1 hr (the third thermal treatment). After the thermal treatments, the resulting fiber was cooled to form a zinc oxide nanofiber. The thermal treatments were performed in the air.

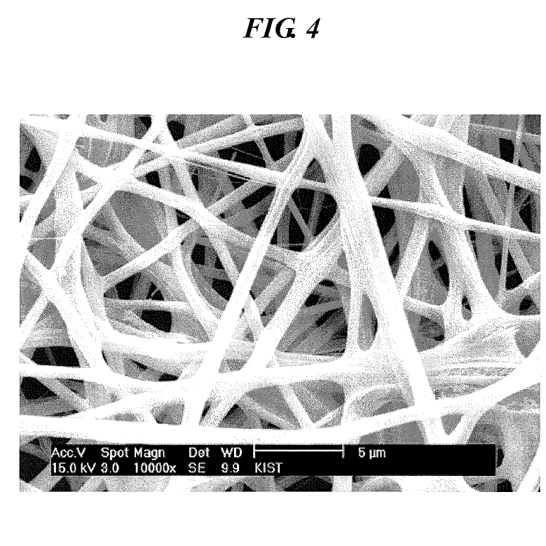

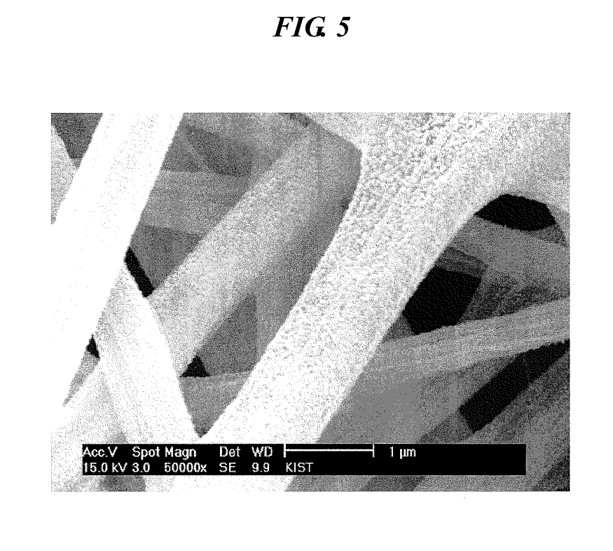

FIG. 4 is an SEM image(×10,000) of the zinc oxide nanofiber fabricated in Example 2 and FIG. 5 is a high magnification SEM image of FIG. 4.

As shown in FIG. 4, the zinc oxide nanofibers having a fiber diameter of 1000 nm were entangled with one another to form a nanofiber web. As shown in FIG. 5, the nanoparticles having an average diameter of 20 nm were close-packed to form the nanofiber having a fiber diameter of 1000 nm. Further, it can be seen that the straight nanofiber having an aspect ratio of 10 or more was fabricated well from FIG. 4, and the nanofiber having an aspect ratio of 100 or more was fabricated continuously from a low magnification SEM image.

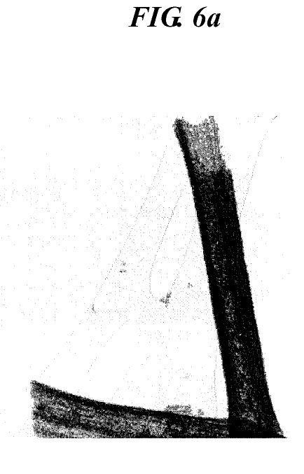

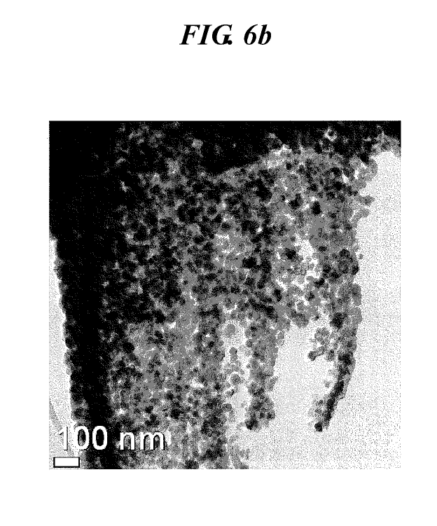

FIG. 6a is a TEM image of the zinc oxide nanofiber and FIG. 6b is a high magnification TEM image of FIG. 6a.

As shown in FIGS. 6a and 6b, the zinc oxide nanoparticles having a diameter of 20 nm were close-packed to form a nanofiber similar to the structure in FIG. 5. Specifically, the fabricated nanofiber comprised nano-sized pores having an average pore diameter of 3 nm or less, and a porosity per unit volume of about 5%. Such structural characteristic of the nanofiber as shown in FIGS. 6a and 6b, results from the sol-gel reaction accompanied by subsequent thermal treatment which induces the generation and growth of the zinc oxide nuclear to facilitate a uniform dispersion and growth of the zinc oxide nuclear in the nanofiber. Especially, it can be seen that the fabricated nanofiber had a stable structure due to the polymer mixture of PVP and PMMA having different molecular weights and glass transition temperatures.

### EXAMPLE 3

### Fabrication of Tin Nanofiber

7.5 g of dimethyformamide (DMF, J. T. Baker) was placed in a 100 mL of bottle. 0.8 g of tin (IV) chloride (Mw 260.5) was added thereto and stirred until they were completely dissolved. To facilitate the spinning, 1 mL of acetic acid was added to the resulting solution and stirred for 1 min. A polymer mixture which is prepared by mixing 0.5 g of polyvinylpyrrolidone (PVP, Mw: 1,350,000, Tg: 180° C.) and 0.5 g of polymethylmetacrylate (PMMA, Mw: 350,000, Tg: 105° C.) in a weight ratio of 1:1 was added thereto and stirred until they were completely dissolved to prepare a tin precursor/PVP-PMMA spinning solution. A small amount of CTAB was added to the spinning solution to facilitate the subsequent electrospinning. The spinning solution thus obtained was loaded in an amount of 10 mL into syringe and injected the surface of a current collector at a rate of 20 μl/min using a 30 G needle while maintaining a potential difference of about 13-15 kV, to form an ultrafine fiber web layer. A stainless steel (SUS) substrate was used as the current collector. The thickness of the ultrafine fiber web layer was controlled to be 10 μm by varying the amount of the spinning solution discharged. The tin oxide precursor/PVP-PMMA complex fiber deposited on SUS was heated at a rate of 1° C./min to 150° C., followed by maintaining for 1 hour in a tube furnace (the first thermal treatment). Then, the resulting composite fiber was heated at a rate of 1° C./min to 250° C., followed by maintaining for 1 hr (the second thermal treatment). And the resulting complex fiber was further heated at a rate of 1° C./min to 500° C., followed by maintaining for 1 hr (the third thermal treatment). After the thermal treatments, the resulting fiber was cooled to form a tin oxide nanofiber. The thermal treatments were performed under a reduction atmosphere (N₂/H₂, 80/20 V/V %).

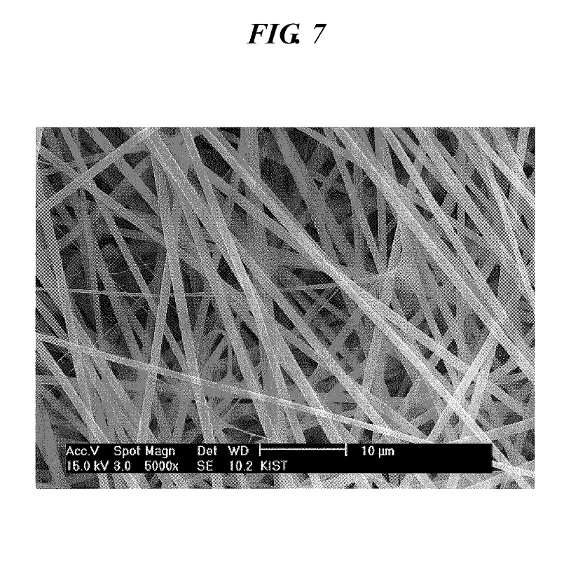

FIG. 7 is an SEM image (×5,000) of the tin precursor/PVP-PMMA composite nanofibers electrospun on the current collector.

As shown in FIG. 7, the tin oxide nanofiber having a fiber diameter of 500-2000 nm was fabricated well

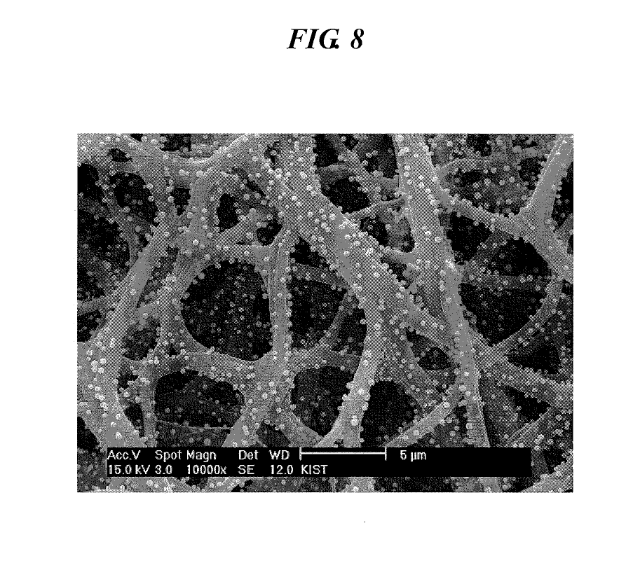

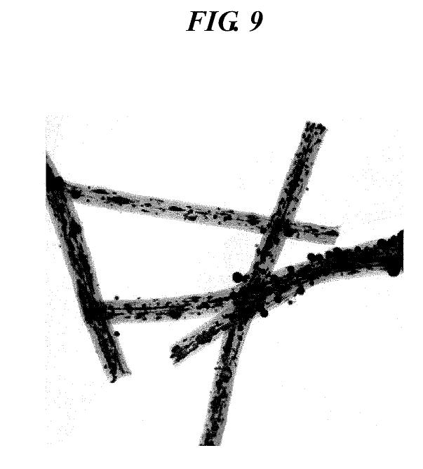

FIG. 8 is an SEM image of the tin-carbon nanofiber fabricated in Example 3 (×10,000) and FIG. 9 is a TEM image of the tin-carbon nanofiber fabricated in Example 3.

As shown in FIGS. 8 and 9, the nanoparticles of a metallic tin were observed inside and outside of the fiber having a smooth surface. The reason for such result is that the residue of PVP-PMMA mixture which did not removed during the third thermal treatment at 500° C. under a reduction atmosphere, induced a formation of amorphous carbon in the nanofiber, and the metallic tin having a low melting point of 230° C. was easily precipitated inside and outside of the nanofiber comprising amorphous carbon to grow into a spherical crystal particle during cooling in the furnace. However, the nanofiber fabricated in Example 3 had lower direction property than those of the tin oxide nanofiber and the zinc oxide nanofiber fabricated in Examples 1 and 2 due to precipitation of the metallic tin having a relatively high density. Further, the nanofiber fabricated in Example 3 comprised nano-sized pores having an average pore diameter of 3 nm or less formed between nanoparticles while the porosity per unit volume of the nanofiber was 5% or less due to the presence of amorphous carbon.

### COMPARATIVE EXAMPLE 1

### Fabrication of Tin Oxide Nanofiber

The tin nanofiber was fabricated using the same procedure as described in Example 3 except using a polymer mixture of polyvinylpyrrolidone and polymethylmethacrylate mixed in a weight ratio of 100:0.

Specifically, 7.5 g of dimethyformamide (J. T. Baker) was placed in a 100 mL of bottle. 0.8 g of tin (IV) chloride (Mw 260.5) was added thereto and stirred until they were completely dissolved. To facilitate the spinning, 1 mL of acetic acid was added to the resulting solution and stirred for 1 min. A polymer mixture which is prepared by mixing 0.5 g of polyvinylpyrrolidone (PVP, Mw: 1,350,000, Tg: 180° C.) and 0.5 g of polymethylmetacrylate (PMMA, Mw: 350,000, Tg: 105° C.) in a weight ratio of 100:0 was added thereto and stirred until they were completely dissolved to prepare a tin precursor/PVP spinning solution. A small amount of CTAB was added to the spinning solution to facilitate the subsequent electrospinning. The spinning solution thus obtained was loaded in an amount of 10 mL into syringe and injected the surface of a current collector at a rate of 20 μl/min using a 30 G needle while maintaining a potential difference of about 13-15 kV, to form an ultrafine fiber web layer. A stainless steel (SUS) substrate was used as the current collector. The thickness of the ultrafine fiber web layer was controlled to be 10 μm by varying the amount of the spinning solution discharged. The tin precursor/PVP composite fiber deposited on SUS was heated at a rate of 1° C./min to 150° C., followed by maintaining for 1 hour in a tube furnace (the first thermal treatment). Then, the resulting composite fiber was heated at a rate of 1° C./min to 250° C., followed by maintaining for 1 hr (the second thermal treatment). And the resulting composite fiber was further heated at a rate of 1° C./min to 500° C., followed by maintaining for 1 hr (the third thermal treatment). After the thermal treatments, the resulting fiber was cooled to form a tin nanofiber. The thermal treatments were performed under a reduction atmosphere (N₂/H₂, 80/20 V/V %).

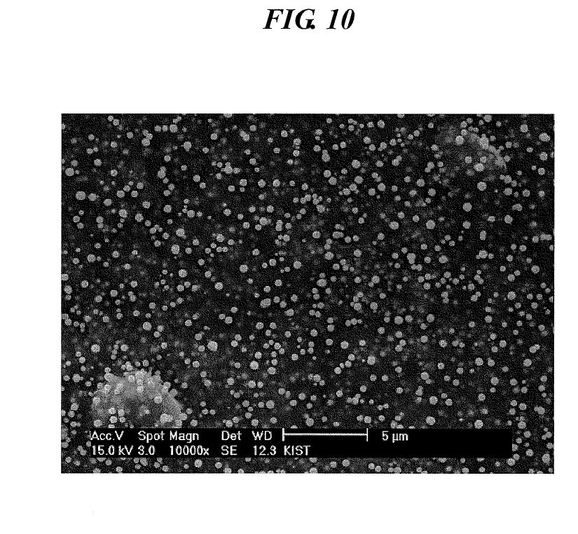

FIG. 10 is an SEM image (×10,000) of the tin-carbon nanofiber fabricated in Comparative Example 1(a mixture ratio of PVP and PMMA: 100:0).

As shown in FIG. 10, the tin containing-amorphous carbon nanofiber which was fabricated by using the tin precursor/PVP spinning solution was collapsed to form a structure of a thin layer, and tin particles were precipitated on the surface and inside of the thin layer. This result shows that the nanofiber prepared by using a single polymer has deteriorative mechanical stability compared to the nanofiber prepared by using a polymer mixture of at least two polymers.

While the invention has been described with respect to the above specific embodiments, it should be recognized that various modifications and changes may be made to the invention by those skilled in the art which also fall within the scope of the invention as defined by the appended claims.

What is claimed is:

1. A nanofiber comprising close-packed nanoparticles, wherein the nanoparticles are selected from the group consisting of a metal, a metal oxide, a metal complex oxide, and a mixture thereof, the nanofiber comprises micropores having an average pore diameter of 0.1 nm to 20 nm formed between nanoparticles and a porosity per unit volume in the range of 0.01% to 10%.

2. The nanofiber of claim 1, which has an aspect ratio (the ratio of the length of the nanofiber to its width) of 100 or more.

3. The nanofiber of claim 1, which has an average fiber diameter of 50 nm to 3000 nm.

4. The nanofiber of claim 1, wherein the nanoparticles have an average particle diameter of 5 nm to 200 nm.

5. The nanofiber of claim 1, wherein the metal is at least one metal selected from the group consisting of Pt, Ni, Au, Fe, Co, Mo, In, Ir, Si, Ag, Sn, Ti, Cu, Pd, and Ru; or an alloy thereof.

6. The nanofiber of claim 1, wherein the metal oxide is selected form the group consisting of a binary system-metal oxide comprising SnO₂, Al₂O₃, TiO₂, Fe₂O₃, ZrO₂, V₂O₅, Fe₂O₃, CoO, Co₃O₄, CaO, MgO, CuO, ZnO, In₂O₃, NiO, MoO₃, and WO₃; a ternary system-metal oxide comprising SnSiO₃, Zn₂SnO₄, CoSnO₃, Ca₂SnO₄, CaSnO₃, ZnCo₂O₄, Co₂SnO₄, Mg₂SnO₄, Mn₂SnO₄, CuV₂O₆, NaMnO₂, NaFeO₂, LiCoO₂, LiNiO₂, SrTiO₃, Li₄Ti₅O₁₂, BaTiO₃, and LiMn₂O₄; a multi component system-metal oxide comprising LiFePO₄, Li[Ni_{1/3}Co_{1/3}Mn_{1/3}]O₂, Li[Ni_{1/2}Mn_{1/2}]O₂, LiNi₁₋ₓCoₓO₂ (0.1≦X≦0.9), LiAl_{0.05}Co_{0.85}Ni_{0.15}O₂, La₁₋ₓSrₓCoO₃ (0.1≦X≦0.9), La_{0.8}Sr_{0.2}Fe_{0.8}Co_{0.2}O₃, La₁₋ₓSrₓMnO₃ (0.1≦X≦0.9), and La₁₋ₓSrₓFeO₃ (0.1≦X≦0.9).

7. The nanofiber of claim 1, wherein the metal complex oxide is selected from the group consisting of Pt—RuO₂, Au—RuO₂, Pt—IrO₂, Pt—TiO₂, Pd—SnO₂, Pd—TiO₂, Ni—Y_{0.08}Zr_{0.92}O₂, Ag—BaTiO₃, Pt—LaNiO₃, and Pt—Y_{0.08}Zr_{0.92}O₂.

8. A method for preparing the nanofiber of claim 1, comprising:
preparing a spinning solution by mixing at least one precursor for metal, metal oxide, or metal complex oxide with a polymer mixture comprising at least two polymers having different molecular weights and glass transition temperatures in a solvent;
spinning the spinning solution to obtain a precursor/polymer complex fiber; and
thermally treating the precursor/polymer complex fiber.

9. The method of claim 8, wherein the polymer mixture comprises a 1st polymer having an average weight molecular of 1,000,000 or more and a 2nd polymer having an average weight molecular of 500,000 or less, and the 1st polymer and 2nd polymer have different glass transition temperatures in the range of 25° C. to 400° C.

10. The method of claim 9, wherein the difference of the glass transition temperatures of the 1st polymer and the 2nd polymer is 30° C. or more.

11. The method of claim 8, wherein the polymer mixture comprises the 1st polymer having an average weight molecular of 1,000,000 or more and the 2nd polymer having an average weight molecular of 500,000 or less in a weight ratio of 0.2:0.8 to 0.8:0.2

12. The method of claim 8, wherein the precursor is used in an amount of 50% to 300% by weight based on the total weight of the polymer mixture.

13. The method of claim 8, wherein the precursor is selected from the group consisting of a metal salt, metal halide; metal alkoxide; metal cyanine; metal sulfide; metal amide; metal cyanide; metal hydride; metal peroxide; metal porphine; metal nitride; metal hydrate; metal hydroxide, and a ester comprising a metal, and the metal is selected from the group consisting of platinum (Pt), nickel (Ni), gold (Au), iron (Fe), cobalt (Co), molybdenum (Mo), indium (In), iridium (Ir), silicon (Si), silver (Ag), tin (Sn), titanium (Ti), cupper (Cu), palladium (Pd), ruthenium (Ru), zinc (Zn), strontium (Sr), lithium (Li), manganese (Mn), lanthanum (La), aluminium (Al), vanadium (V), barium (Ba), and magnesium (Mg); and a mixture thereof.

14. The method of claim 8, wherein the solvent is selected from the group consisting of dimethylformamide, acetone, tetrahydrofuran, toluene, water, ethanol, and a mixture thereof.

15. The method of claim 8, wherein the spinning solution further comprises an additive selected from the group consisting of acetic acid, stearic acid, adipic acid, ethoxyacetic acid, benzoic acid, nitric acid, cetyltrimethylammonium bromide, and a mixture thereof.

16. The method of claim 8, wherein the spinning is performed by electrospinning, melt-blowing, flash spinning, or electrostatic melt-blowing.

17. The method of claim 8, wherein the thermal treatment comprises the steps of:
conducting a first thermal treatment by heating the complex fiber at a rate of 1° C. to 2° C. per minute, followed by maintaining at the temperature of 50° C. to 200° C.;
conducting a second thermal treatment by heating the fiber obtained from the first thermal treatment at a rate of 1° C. to 2° C. per minute, followed by maintaining at the temperature of 250° C. to 350° C.; and
conducting a third thermal treatment by heating the fiber obtained from the second thermal treatment at a rate of 1° C. to 5° C. per minute, followed by maintaining at the temperature of 300° C. to 900° C.
